(19) United States
(12) Patent Application Publication
(10) Pub. No.: US 2025/0368322 A1
(43) Pub. Date: Dec. 4, 2025

(54) ADAPTIVE FLUIDIC PROPULSIVE SYSTEM

(71) Applicant: JETOPTERA, INC., Edmonds, WA (US)

(72) Inventor: Andrei Evulet, Edmonds, WA (US)

(73) Assignee: JETOPTERA, INC., Edmonds, WA (US)

(21) Appl. No.: 19/236,946

(22) Filed: Jun. 12, 2025

Related U.S. Application Data
(63) Continuation of application No. 18/562,538, filed on Nov. 20, 2023, now abandoned.
(60) Provisional application No. 63/190,762, filed on May 19, 2021.

(51) Int. Cl. B64C 15/14; B64C 9/38; F02K 1/12; F02K 1/36; F02K 1/46

(52) U.S. Cl. CPC B64C 15/14; B64C 9/38; F02K 1/12; F02K 1/36; F02K 1/46

(57) ABSTRACT

A propulsion system includes at least one compressor, multiple conduits, a multiple-way valve, and at least one thrust augmentation device. A series of flaps can be retracted, tilted and operated in conjunction with the at least one thrust augmentation device. A converging channel in fluid communication with the valve is configured to allow expansion to ambient of a compressed air stream in a preferred single direction. The at least one thrust augmentation device each contains a mixing section, a throat section and a diffusor. Each said augmentation device receives compressed air from the at least one compressor via at least one of the conduits and valve and uses pressurized air as motive gas to generate thrust by fluidically entraining ambient air, mixing it with the motive gas and ejecting the motive gas at high velocities via the diffusor.

### PRIORITY CLAIM

The present application is a continuation of U.S. application Ser. No. 18/562,538 filed Nov. 20, 2023, which is a 371 National Stage application which claims priority from PCT/US2022/030134 filed May 19, 2022, which claims priority to U.S. Provisional Patent Application Ser. No. 63/190,762 filed May 19, 2021, all of which are incorporated herein by reference as if fully set forth herein.

### COPYRIGHT NOTICE

This disclosure is protected under United States and/or International Copyright Laws. C 2023 Jetoptera, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

Existing VTOL and STOL propulsors involve rotary wings or tilting rotors or ducted fans. The challenge of any VTOL aircraft is the propulsor of choice. Helicopters are excluded from this discussion, as the ubiquitous choice of low-speed VTOL. The propulsor for the current high-speed V/STOL aircraft in military application relies on tilting, large rotors, such as the V-22 Osprey or on large, fixed ducted fans such as the F-35 fighter jet. The challenge with the latter is that the fixed ducted fan becomes dead weight for 99% of the mission time, when in non-vertical flight segments. This limits the payload capabilities; it is very complex and unaffordable for smaller manned or unmanned applications. The challenge with the V22 rotors is that they are of large footprint, must tilt with high precision yet they still limit the maximum speed due to the limitations of the tip speed of the rotors. The V22 history of development has also shown it has critical flaws that cost a lot of lives. A high-speed enabling VTOL propulsor is needed, one that can propel an aircraft at more than 400 knots. Most eVTOL aircraft employ tilting, multiple propellers which are also noisy and speed limiting due to the very nature of the propellers. Many of the hundreds of the eVTOL platforms proposed use fixed propellers, multiple, distributed for the vertical takeoff and a single pusher propeller for horizontal flight, and they are severely limited in speeds

While engineers are implementing sophisticated and high-cost technologies to enable propellers to maximize their hovering efficiency, present day smaller propellers are suffering from low efficiencies and high costs. The speeds for cargo drones and Urban Air Mobility flying cars (air taxis) are limited to low values, the propellers are noisy and inefficient at those sizes. What is needed is a method of propulsion that can be employed without the shortcomings of the propellers.

### BRIEF DESCRIPTION OF THE DRAWINGS

FIG. 1 illustrates the overall Adaptive Fluidic Propulsive System.

FIG. 2 illustrates the VTOL and STOL configuration of the present invention.

FIG. 3 illustrates the VTOL to Cruise configuration of the present invention.

FIG. 4 illustrates the low-speed Cruise configuration of the present system

FIG. 5 illustrates the high-speed Cruise configuration of the present system.

FIG. 6 illustrates the present system as deployed to a particular aircraft.

### DETAILED DESCRIPTION OF THE PREFERRED EMBODIMENT

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

The present embodiments disclosed in this application provide an adaptive propulsive system that operates in conjunction with an air compressor or fan. Rather than seeking to maximize thrust by accelerating a mass of air to the highest velocity possible like a typical turbofan engine, the preferred embodiment of the present invention produces several streams of pressurized air into an array of ejectors and/or simple nozzles creating force used in all phases of flight in a precise sequence for a precise mission section need and in conjunction with lift generating surfaces that enable particular capabilities of the aircraft that uses said propulsive system.

A propulsor according to an embodiment is designed from the principles of thrust augmentation using special ejectors and Upper Surface Blown lift augmentation. The air supply may come from a turbo-compressor, a turbofan or any air compressor that produces, preferably, at least a 1.5:1 pressure ratio supply of air in sufficient quantities.

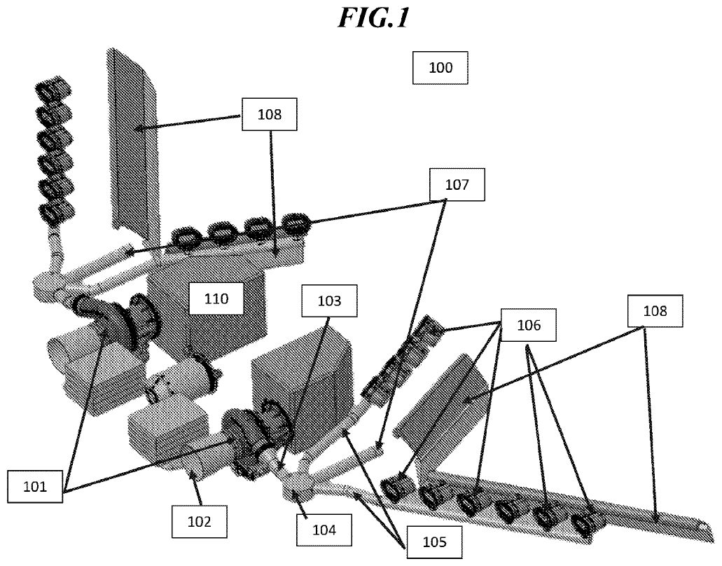

In FIG. 1, which illustrates the VTOL configuration 100 of an embodiment of the present invention, compressed air is produced by the air compressors 101. These compressors 101 may be a turbofan bypass air stream or any type of fan or compressor that can produce a large amount of flow at specifically at least 1.5 pressure ratio to ambient pressure. The air compressed by the compressor may be routed to ejectors/thrusters and/or may be used for other purposes, including being directed into the intake 110 of the secondary nozzle for cooling, augmentation of thrust, cabin pressurization, or other uses. As with typical turbocharger compressors, the compressor may have at peak operation a pressure ratio preferably 2.5 or more. A valve may be present on the compressor discharge volute to direct the compressed air to either the secondary compressor or outside the gas generator, as need may be.

The compressed air can use its own air intake 102 and supply said air via a compressor exit conduit 103 to a 3- or 4-way valve, 104. The valve 104 can serve as distributor of said stream of compressed air from compressor 101 towards a series of conduits 105 leading to various thrust generating devices.

In one embodiment, the compressed air is directed to two conduits that distribute the flow to a series of thrusters 106 called fluidic thrusters, or ejectors, that are aligned with the wing and flaps 108 of an aircraft. At static or low wind conditions this motive air creates a massive amount of entrained secondary air to generate thrust but also creates a wall jet in an adjacent pattern to the flaps 108 and on the suction side of said flaps, hence the name Upper Surface Blown Wing or Flaps. Such flow that was amplified to 5-20 times the flow rate of compressed air can be ejected at speeds between 150 to 300 mph over the flaps 108, generating additional lift by at least 50% compared to the flaps in head wind conditions and generating Lift Coefficients of exceeding 10.0.

The compressed air may be prevented from flowing towards the simple nozzles 107 and expanded to the ambient by the valve 104. The configuration of the valve 104 is such that it only allows the flow to the ejectors 106 system at take-off, landing or hovering (i.e., during vertical flight portion of the mission). The valve 104 can have several positions during flight and can enable the high speed in horizontal flight at higher altitudes by strictly blocking the flow to elements 106 and only allowing flow to nozzles 107.

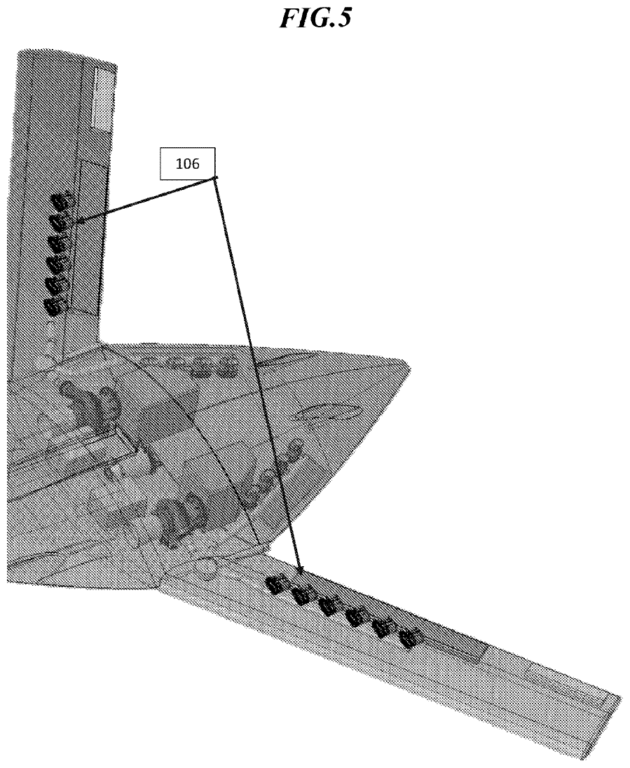

Moreover, nozzles 107 distribute the efflux resulting from their entrainment of the air in the front and blowing it over the high portion of the flaps and wingspan 108, generating a low-pressure area that creates better circulation. This system would produce results similar to high lift systems or powered lift systems used in the past, except an additional factor of lift generation is introduced by the low pressure area in front of said thrust-augmenting ejectors 106: by the way it is introduced, the motive air from the compressor 101 is generating a depression in front of the thrusters 106 hence facilitating a Boundary Layer Ingestion phenomenon, which allows the entire wing 108 of such system to operate at extremely high angles of attack without stall or separation. Thus, in an example where there is a 1 lb/s flow, with a Pressure Ratio (PR) of 1.8 supplied to four thrust-augmenting ejectors 106 with emerging efflux of 150 mph blown in an adjacent manner to the upper surface of the airfoil and flaps 108, the resulting lift generated would be between 100% higher at very low speed to 25% higher at 100 knots speeds versus the clean wing without the use of such thruster-augmentors. The forward force is still produced by said ejectors 106 but at the same time an additional lift is generated together with the forward thrust, in effect augmenting lift by 2 times in comparison with the “clean” wing. The clean wing can be observed in FIG. 5, where said thrusters augmentors are now retracted into the wing, hence the wing is “clean” and of lower drag, and with an overall Lift to Drag ratio larger than when the thruster-augmentors 106 are exposed.

In one example the 1 lb/s motive air flow is produced using a compressor such as the ones typically employed in turbochargers or electric compressors, operating at a maximum pressure ratio of 2.0:1 and at isentropic efficiencies of exceeding 85%; in an embodiment the input mechanical or electrical power need to drive the air compressor is 38 horse power (HP); when deployed at the correct angle of tilt and across the wing in a Upper Surface Blown configuration over the deployed flaps, the lift force generated at speeds as low as 10 knots is doubled, compared to the case where a clean wing is used at the same head wind velocity (10 knots) but no thruster augmentors are active or present. This would allow the aircraft to perform super-short take off and landings or eventually take off vertically in headwinds as for example on the deck of a ship placed into the wind. Typical values of lift force that can be obtained with the blown wing example in 10 knots head wind conditions and flaps deployed could be around 200 lbf for 38 HP input, resulting in a ratio of 5.26 lbf/HP, which is a common value for the hovering efficiency of a tilt rotor such as the V22 Osprey or a helicopter as explained by Maiselet al.-NASA SP-2000-4517, “The History of the XV-15 Tilt Rotor Research Aircraft: From Concept to Flight” (Bibliographic data) http://history.nasa.gov/monograph17.pdf. It follows that an aircraft may be able to produce a vertical thrust of multiples of 200 lbf in low-speed headwinds by employing multiples of 38 HP compressors which may be powered by mechanical or electrical or combinations of the two sources. A 380 HP load directed to the compressor of an Auxiliary Power Unit may hence produce, in combination with the fluidic thruster augmentors and the flaps of the blown wing, a vertical force of 2000 lbf by employing a motive air stream of 10 lb/s at a pressure ratio of 1.8 to ambient.

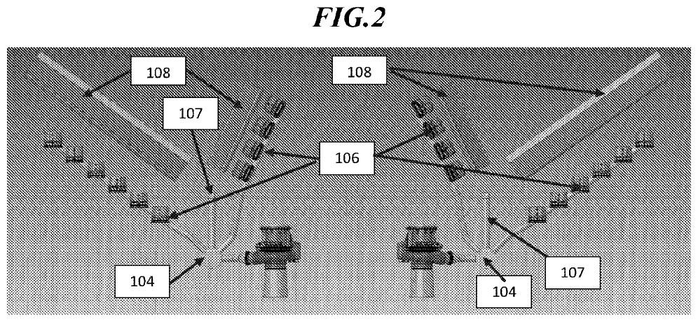

It would be then advantageous that once airborne and gaining forward speed, that the array of thruster-augmentors or ejectors 106 are gradually retracted into the wing. In FIG. 2, at the takeoff vertically condition or super short take off conditions, all thrusters 106 are deployed and actively receiving compressor air but once in the air, a large fraction is retracted into the wing after valve 104 blocks the flow to one of the branches and directs most of the reduced flow to the remaining thrusters still left on the wing 108. At the same time flaps are being retracted as the aircraft is gaining speed and lift contribution of the wing due to forward speed is increasing. The fluidic thrusters are however still augmenting the lift by a combination of blowing over the upper surface of the wing and smaller flaps and by suction and boundary layer ingestion in the front, allowing the wing to operate at otherwise conditions at which the clean wing would stall and aggressive angles of attack unachievable by the clean wing at the given speed. The aircraft would continue to accelerate in flight until the flaps are no longer needed and speed ensures lift sufficient for flight stability and further acceleration, yet the thrusters can no longer provide the acceleration and the drag and thrust cancel each other.

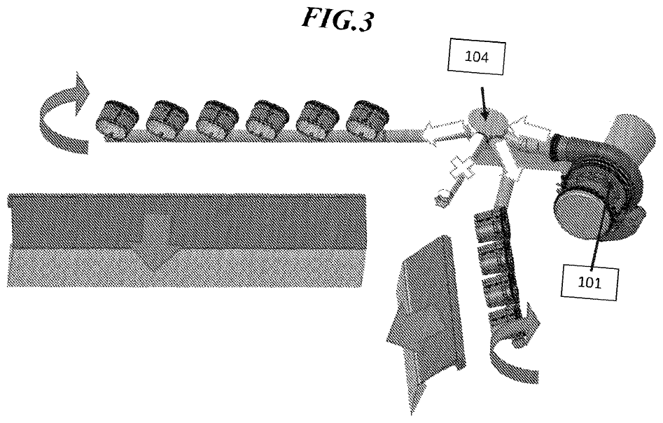

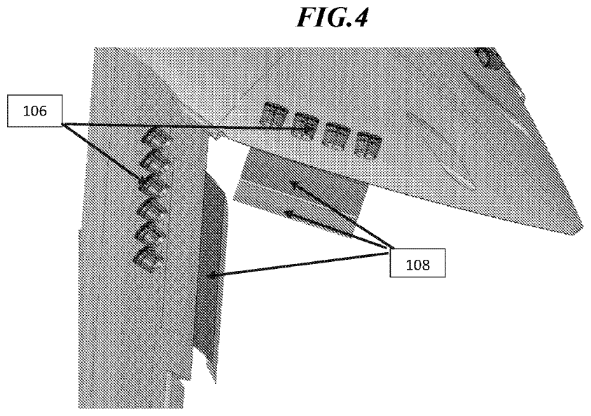

In one embodiment a blended wing body as shown in FIG. 5 has taken off vertically by deployment of all the thrusters 106 and flaps as explained and illustrated in FIGS. 1-4 and has now reached a speed of exceeding 100 knots but less than 300 knots and cannot further accelerate to higher speed by means of increasing the flow to the thrusters. Up to that particular point, the thrusters have been used fully deployed with the flaps then gradually retracted and rendered inactive by the distribution valve 104, which has kept inactive the simple expansion nozzle conduits 107 and shut off part of the thrusters supply conduits forcing the air solely through the remaining exposed thrusters. With no further acceleration available, the remaining thrusters are now rendered inactive and the flow is shut off to them, as they are being retracted into the wing. Concomitantly with the action of retracting all the thruster into the wing, the fuselage and wings of the aircraft become more aerodynamic and lift to drag ratio is increased by reduction of the drag due to retraction of the thrusters. Gradually all air otherwise supplied to the remaining thrusters is fed now to the conduits 107 and the jet formed by the expansion of said air to the ambient is now producing all the thrust of the aircraft. The sudden drop in drag determines a smaller need for the thrust otherwise produced with the thrusters, which augment thrust at all conditions. As such, the same condition of flight (constant speed altitude and attitude) can be maintained while the emerging expansion jets produce the required thrust. At this point a blended wing body aircraft that typically produces a performance of lift to drag of 20-25 would only require a small thrust force to accelerate further the aircraft to high speeds exceeding 400 knots.

Conversely, after the segment of the mission is complete at high speeds and without the use of the thrusters which are hidden in the wing and fuselage, by exposing partially the thrusters of the wing the aircraft is slowing down while air is re-distributed from the simple expansion nozzle conduit to the conduits feeding the thrusters 106. Furthermore, at even slower speeds the valve 104 opens now to supply all the thrusters including the ones on the wing and fuselage and the flaps are deployed as well, generating again a considerable thrust and lift augmentation and allowing the aircraft to slow down to hovering and vertical landing. With this approach, several achievements are made:

The thrusters/augmentors are deployed for vertical flight to work with the flaps and augment lift to at least two times the entitlement without blowing air over the upper surface of said flaps and wings

The thrusters and flaps are gradually retracted during the transitions from vertical to horizontal and acceleration flight, creating a stable and smooth flight dynamic transition and acceleration. The retraction of the flaps and of thrusters may be done in conjunction with well-controlled compressor air delivery.

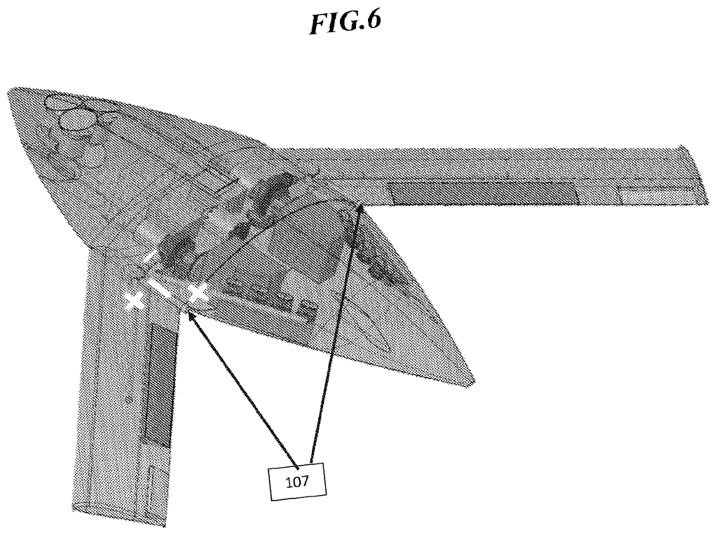

FIG. 5 illustrates the aircraft in cruise condition using fluidic propulsion with active thrusters 106 on the wing 108. Augmentation of both lift and thrust is still achieved and eventually a terminal forward velocity of the aircraft is achieved at which point no increase in air flow from the compressor can generate additional thrust. The point is where the thrust augmentation no longer serves the purpose of acceleration due to increased drag, and hence the aircraft becomes more aerodynamic by directing the flow into the simple nozzles using valve 104. FIG. 6 shows the high-speed configuration of the aircraft with clean wings and fuselage, low drag and propelled by compressed air expanded via conduits 107 and convergent nozzle.

FIG. 6 is showing in effect an aircraft that has a BWB architecture and propelled similarly to a turbofan powered aircraft, whereas the turbofan is in effect a compressor or series of compressors 101 operating at a pressure ratio of under 2:1, similarly to a small turbofan with a fan pressure ratio of under 2:1.

Since BWB aircraft have been demonstrated to produce remarkable lift to drag ratios, a small need for thrust forward exists and the L/D of 25 or higher can ensure a high endurance, significant range and speed while also allowing vertical take-off and landing. Such combination does not exist today with rotary wing aircraft.

Air compressors onboard may be electric or mechanically driven, so agnostic to the input.

FIG. 6 also shows potential fuel tank, electric generator and battery onboard that can power the aircraft and the 3-in-1 propulsor.

The 3-in-1 propulsor can supply VTOL SSTOL, STOL or CTOL operations, hovering in configuration 1 where in one embodiment the FPS is deployed with flaps in an Upper Surface Blown system to generate enough vertical lift at very low or zero forward speeds. In configuration 2 where it strictly provides forward thrust and it has partially retracted the FPS thrusters into the fuselage and wing. And a third configuration in which all FPS thrusters are retracted and hidden, providing a very high L/D number and allowing acceleration to speeds not achievable by rotary wing aircraft.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

We claim:

1. A propulsion system comprising:
at least one compressor;
multiple conduits;
a multiple-way valve;
at least one thrust augmentation device,
wherein the at least one compressor includes an intake opening and at least one outlet port in fluid communication with the valve, the valve being in fluid communication with the conduits,
at least one of the conduits allowing retraction of the at least one thrust augmentation device and exposure inside and outside a wing and fuselage, respectively, of an aircraft or vessel;
a series of flaps that can be retracted, tilted and operated in conjunction with the at least one thrust augmentation device for maximum lift and thrust generation;
a converging channel in fluid communication with the valve configured to allow expansion to ambient of a compressed air stream in a preferred single direction, the at least one thrust augmentation device each containing a mixing section, a throat section and a diffusor, whereby each said augmentation device receives compressed air from the at least one compressor via at least one of the conduits and valve and uses pressurized air as motive gas to generate thrust by fluidically entraining ambient air, mixing it with the motive gas and ejecting the motive gas at high velocities via the diffusor.

2. The system according to claim 1 wherein the compressor is driven by an electric motor or a mechanical device.

3. The system according to claim 1 wherein the multiple conduits are in communication with the valve and can modulate the flow to multiple thrust augmentation devices to assist the attitude control of the aircraft powered by said propulsion system.

4. A method of flying an aircraft or hovercraft comprising:
accelerating a compressor to maximum power with feeding distribution valves and supplying multiple thrust augmenting devices and balancing an attitude of the aircraft by closing and opening control valves distributing compressed air to the thrust augmenting devices and for vertical hovering, take-off and landing;
positioning flaps of said aircraft to receive efflux of said thrust augmenting devices to augment the amount of lift while minimizing the required forward speed of said aircraft; and
positioning wings of said aircraft to exploit low-pressure areas of the thrust augmenting devices such that boundary layer ingestion results preventing the wings and flaps from stalling.

5. A method of flying level an aircraft or hovercraft comprising:
Accelerating or decelerating a compressor to produce more or less flow to thrust augmentors supplied with compressed air from compressor output;
opening or closing a distribution valve to supply or block a portion of the compressed air to the thrust augmentors in communication with a fluid network;
opening or closing control valves that distribute the compressed air to thrust augmentors to control roll, yaw and pitch;
opening and closing several conduits to bypass the conduits communicating with the thrust augmentors and direct the flow to a conduit leading to a propulsion nozzle pointing mainly in the direction opposite to the direction of flight; and
rotating or swiveling the thrust augmenting devices into and out of wings and fuselage of said aircraft.

6. The propulsion system according to claim 1 wherein the ejectors contain one or more fuel injection nozzles for augmentation of thrust during short periods of time.
